(19) United States
(12) Patent Application Publication
(10) Pub. No.: US 2025/0127321 A1
(43) Pub. Date: Apr. 24, 2025

(54) Storage Hook Device

(71) Applicant: Patrick McCarthy, Big Lake, MN (US)

(72) Inventor: Patrick McCarthy, Big Lake, MN (US)

(21) Appl. No.: 18/924,556

(22) Filed: Oct. 23, 2024

Related U.S. Application Data
(60) Provisional application No. 63/592,352, filed on Oct. 23, 2023.

(51) Int. Cl. A47G 29/087; F16B 45/00

(52) U.S. Cl. CPC A47G 29/087; F16B 45/00

(57) ABSTRACT

A storage hook device is provided. The device is comprised of a hub washer that is received by a body. A raised area of the hub washer extends into the body via an opening of the body. The raised area is comprised of an opening that allows a fastener, such as but not limited to a screw, to be inserted through the raised area opening and into a surface (ex. a ceiling or a wall) while the area guides and supports the fastener. Then, at least one hook can be placed through at least two horizontal openings in the body to suspend the hook from the body. Once suspended from the bottom, the hook can receive at least one item to store the item in a hung manner.

### CROSS-REFERENCE TO RELATED APPLICATION

The present application claims priority to, and the benefit of, U.S. Provisional Application No. 63/592,352, which was filed on Oct. 23, 2023, and is incorporated herein by reference in its entirety.

### FIELD OF THE INVENTION

The present invention relates generally to the field of storage hooks. More specifically, the present invention relates to a storage hook device comprised of a washer and body two-part mounting system that allows a user to easily secure the device to a surface via a fastener. At least one hook can then be suspended from the body of the device to allow an item to be hung for storage. Accordingly, the present disclosure makes specific reference thereto. Nonetheless, it is to be appreciated that aspects of the present invention are also equally applicable to other like applications, devices, and methods of manufacture.

### BACKGROUND

Storing items directly on the ground can result in a significant accumulation of clutter on the floor. This often leads to a disorganized and untidy space, making it difficult to locate items quickly. As a result, many individuals utilize storage hooks mounted on a wall or ceiling surface. Said hooks offer a neat and efficient way to organize various items within a storage area, or for aesthetically hanging objects like potted plants in outdoor settings, thereby enhancing the visual appeal of the space. However, the installation of storage hooks can be a challenging task, especially for individuals who may not possess considerable physical strength or dexterity. This difficulty arises from the need to securely anchor the hooks, which often requires drilling into hard surfaces or dealing with complicated mounting hardware.

Therefore, there exists a long-felt need in the art for an improved storage hook. There also exists a long-felt need in the art for a storage hook device. More specifically, there exists a long-felt need in the art for a storage hook device that is easier to install than existing storage hooks and existing storage hook installation methods.

The subject matter disclosed and claimed herein, in one embodiment thereof, comprises a storage hook device. The device is comprised of a hub washer that is received by a body. A raised area of the hub washer extends into the body via an opening of the body. The raised area is comprised of an opening that allows a fastener, such as but not limited to a screw, to be inserted through the raised area opening and into a surface (ex. a ceiling or a wall) while the area guides and supports the fastener. Then, at least one hook can be placed through at least two horizontal openings in the body to suspend the hook from the body. Once suspended from the bottom, the hook can receive at least one item to store the item in a hung manner.

In this manner, the storage hook device of the present invention accomplishes all the forgoing objectives and provides an improved storage hook. More specifically, the device provides a storage hook that is easier to install than existing storage hooks and existing storage hook installation methods due to the washer and body system and guiding feature of the raised area of the washer.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a storage hook device comprised of at least one hub washer, at least one body, and at least one hook. The hub washer is preferably circular and is used to initially attach the device to a surface, such as but not limited to a ceiling surface. More specifically, the hub washer is comprised of a flat top surface that contacts the ceiling surface. The bottom surface is comprised of a raised area, wherein the raised area is comprised of at least one opening.

The body is generally cylindrical in shape and is comprised of a first end and a second end. The first end is comprised of an opening with a diameter larger than the diameter of the raised area such that the raised area can fit inside the opening. In this manner, the washer can be positioned such that the raised area is inside the opening and at least one fastener (preferably a flat head screw) can be placed through both openings and into the surface to secure the washer and body to the surface. The diameter of the opening of the washer is preferably less than the diameter of the head of the fastener such that the fastener secures the body to the washer while secured through both into the surface. During installation, the raised area acts as a guide for the fastener to streamline attachment to the surface. The device is also comprised of at least one hook. Further, the body is comprised of at least two horizontal openings that allow a first end of the hook to be placed through the body such that the hook is suspended from the body.

The present invention is also comprised of a method of using the device. First, a device is provided comprised of at least one hub washer comprised of at least one opening; a body comprised of a first opening, a second opening, a third opening and a fourth opening; at least one fastener; and at least one hook. Then, the hub washer can be placed against the first end of the body such that the raised area of the washer extends through the first opening of the first end of the body. Then, the fastener can be inserted through the opening and into a horizontal or vertical surface. Next, a first end of the hook can be inserted through both openings of the body such that the hook is suspended from the body in a position wherein a vertical axis of the hook is generally parallel with a vertical axis of the body or a vertical axis of the hook is generally perpendicular to a horizontal axis of the body. Finally, an item can be hung from the hook for storage.

Accordingly, the storage hook device of the present invention is particularly advantageous as it provides an improved storage hook. More specifically, the device provides a storage hook that is easier to install than existing storage hooks and existing storage hook installation methods due to the washer and body system and guiding feature of the raised area of the washer. In this manner, the storage hook device overcomes the limitations of existing storage hooks and methods of storage hook installation known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of a hub washer of one potential embodiment of a storage hook device of the present invention in accordance with the disclosed architecture;

FIG. 2 illustrates a perspective view of a body of one potential embodiment of a storage hook device of the present invention in accordance with the disclosed architecture;

FIG. 3 illustrates a perspective view of a hook of one potential embodiment of a storage hook device of the present invention in accordance with the disclosed architecture;

FIG. 4 illustrates a side cross-sectional view of one potential embodiment of a storage hook device of the present invention while attached to a horizontal surface in accordance with the disclosed architecture;

FIG. 5 illustrates a perspective view of one potential embodiment of a storage hook device of the present invention while attached to a horizontal surface in accordance with the disclosed architecture;

FIG. 6 illustrates a perspective view of one potential embodiment of a storage hook device of the present invention while attached to a vertical surface in accordance with the disclosed architecture; and

FIG. 7 illustrates a flowchart of a method of using one potential embodiment of a storage hook device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved storage hook. There also exists a long-felt need in the art for a storage hook device. More specifically, there exists a long-felt need in the art for a storage hook device that is easier to install than existing storage hooks and existing storage hook installation methods.

The present invention, in one exemplary embodiment, is comprised of a storage hook device. The device is comprised of at least one hub washer, at least one body, and at least one hook. The hub washer is preferably circular and is used to initially attach the device to a surface, such as but not limited to a ceiling surface. More specifically, the hub washer is comprised of a flat top surface that contacts the ceiling surface. The bottom surface is comprised of a raised area, wherein the raised area is comprised of at least one opening.

The body is generally cylindrical in shape and is comprised of a first end and a second end, wherein the first end is comprised of an opening with a diameter larger than the diameter of the raised area such that the raised area can fit inside the opening. As a result, the washer can be positioned such that the raised area is inside the opening and at least one fastener (preferably a flat head screw) can be placed through both openings and into the surface to secure the washer and body to the surface. It should be noted that the diameter of the opening of the washer is preferably less than the diameter of the head of the fastener such that the fastener secures the body to the washer while secured through both into the surface. During installation, the raised area acts as a guide for the fastener to streamline attachment to the surface. The device is also comprised of at least one hook. Further, the body is comprised of at least two horizontal openings that allow a first end of the hook to be placed through the body such that the hook is suspended from the body.

The present invention is also comprised of a method of using the device. First, a device is provided comprised of at least one hub washer comprised of at least one opening; a body comprised of a first opening, a second opening, a third opening and a fourth opening; at least one fastener; and at least one hook. Then, the hub washer can be placed against the first end of the body such that the raised area of the washer extends through the first opening of the first end of the body. Then, the fastener can be inserted through the opening and into a horizontal or vertical surface. Next, a first end of the hook can be inserted through both openings of the body such that the hook is suspended from the body in a position wherein a vertical axis of the hook is generally parallel with a vertical axis of the body or a vertical axis of the hook is generally perpendicular to a horizontal axis of the body. Finally, an item can be hung from the hook for storage.

Accordingly, the storage hook device of the present invention is particularly advantageous as it provides an improved storage hook. More specifically, the device provides a storage hook that is easier to install than existing storage hooks and existing storage hook installation methods due to the washer and body system and guiding feature of the raised area of the washer. In this manner, the storage hook device overcomes the limitations of existing storage hooks and methods of storage hook installation known in the art.

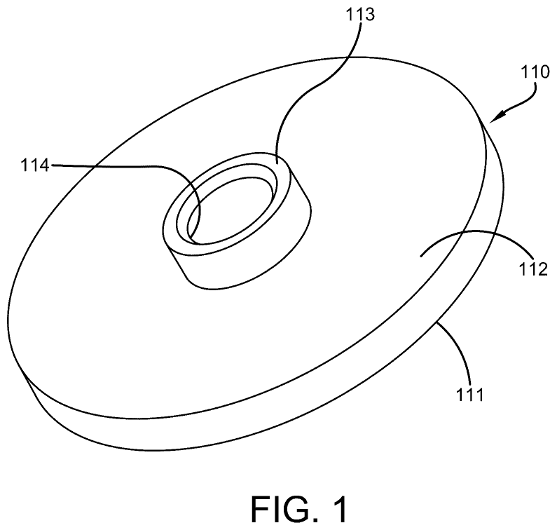

Referring initially to the drawings, FIG. 1 illustrates a perspective view of a hub washer of one potential embodiment of a storage hook device of the present invention in accordance with the disclosed architecture. The device 100 is comprised of at least one hub washer 110, at least one body 120, and at least one hook 150. All components of the device 100 may be made from a plastic, wood, metal, or any other material known in the art.

The hub washer 110 is preferably circular and is used to initially attach the device 100 to a surface 10, such as but not limited to a ceiling surface 10. More specifically, the hub washer is comprised of a flat top surface 111 that contacts the surface 10. The bottom surface 112 is comprised of a raised area 113, wherein the raised area 113 is comprised of at least one opening 114.

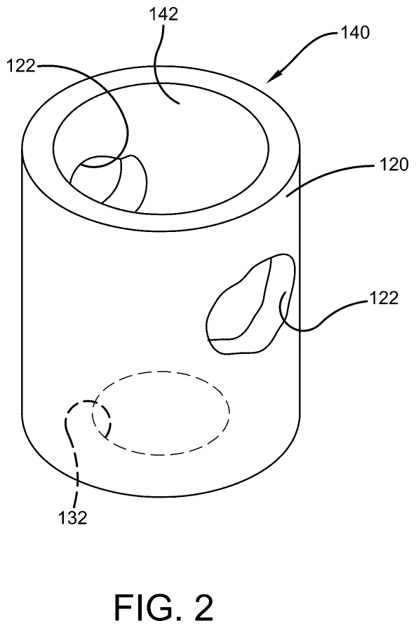

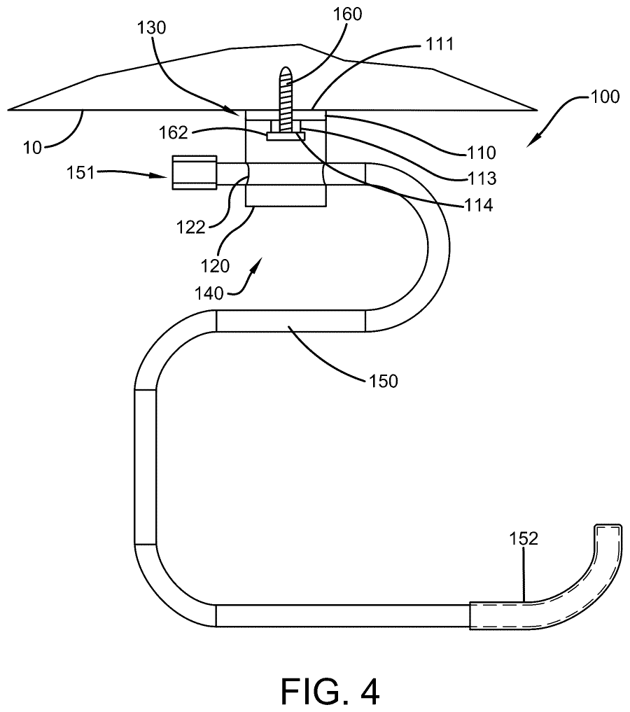

The body 120 is generally cylindrical in shape. The body 120 is comprised of a first end 130 and a second end 140, as seen in FIG. 2. The first end 130 is comprised of an opening 132. The diameter of the opening 132 is larger than the diameter of the raised area 113 such that the raised area 113 can fit inside the opening 132. In this manner, the washer 110 can be positioned such that the raised area 113 is inside the opening 132 and at least one fastener 160 can be placed through both openings 114,132 and into the surface 10 to secure the washer 10 and body 120 to the surface 10, as seen in FIG. 4. The fastener 160 may be any fastener type but is preferably a flat head screw. The diameter of the opening 114 of the washer 110 is preferably less than the diameter of the head 162 of the fastener 160 such that the fastener 160 secures the body 120 to the washer 110 while secured through both into the surface 10. To allow for access to the openings 114,132, the second end 140 of the body 120 is comprised of at least one opening 142. During installation, the raised area 113 acts as a guide for the fastener 160 to streamline attachment to the surface 10. In one embodiment, the body 120 can spin 360 degrees relative to the vertical axis of the washer 110. In another embodiment, the washer 110 is integrally formed to the body 120.

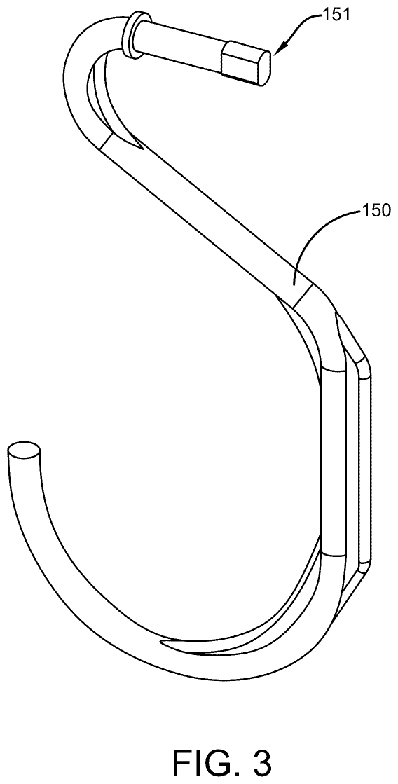

The device 100 is also comprised of at least one hook 150, as seen in FIG. 3. The hook 150 may be any shape, size, configuration, angle, etc. of hook. In one embodiment, the hook 150 is covered with a protective coating, such as but not limited to rubber or wax, in order to not damage any items hung from the hook 150 during storage.

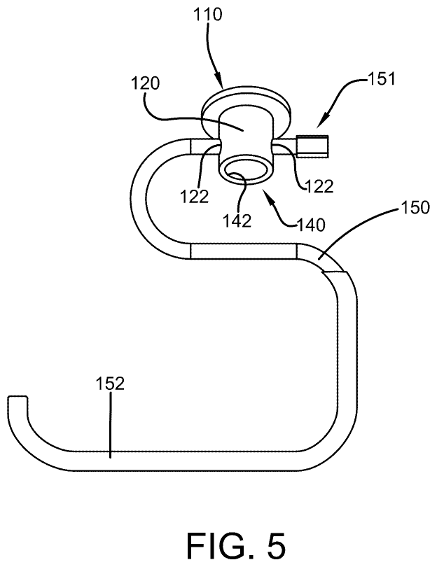

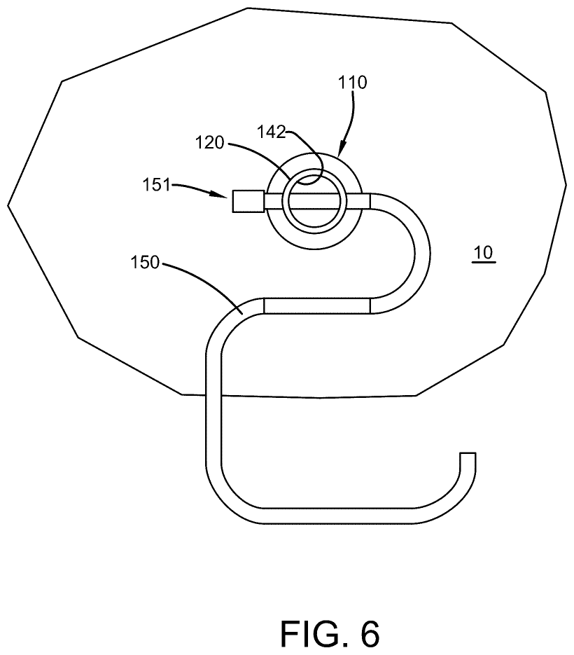

The body 120 is also comprised of at least two horizontal openings 122. The openings 122 allow a first end 151 of the hook 150 to be placed through the body 120 such that the hook 150 is suspended from the body 120. In one embodiment, the first end 151 is shaped such that it cannot easily back out from the openings 132. The openings 132 and end 151 may be any shape, size, or configuration. In one embodiment, the openings 122 and end 151 are shaped such that the end 151 can only fit through the openings 122 when the end 151 is positioned at a first angle. Once through the openings 122, the end 151 can be rotated to a second angle (wherein a vertical axis of the hook 150 is generally parallel with a vertical axis of the body 120 at said angle when the device 100 is suspended from a horizontal surface (i.e., a ceiling surface) as seen in FIG. 5; when the device 100 is suspended from a vertical surface (i.e., a wall surface), the vertical axis of the hook 150 may be generally perpendicular with a horizontal axis (i.e., the axis of the openings 132,142) of the body 120 as seen in FIG. 6) such that the hook 150 is in a useable position and the end 151 cannot back out of the openings 122.

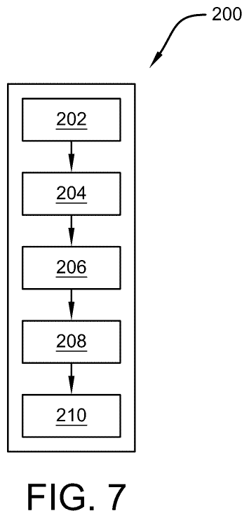

The present invention is also comprised of a method of using 200 the device 100, as seen in FIG. 7. First, a device 100 is provided comprised of at least one hub washer 110 comprised of at least one opening 114; a body 120 comprised of a first opening 132, a second opening 142, a third opening 122 and a fourth opening 122; at least one fastener 160; and at least one hook 150 [Step 202]. Then, the hub washer 110 can be placed against the first end 130 of the body 110 such that the raised area 113 of the washer 110 extends through the first opening 132 of the first end 130 of the body 120 [Step 204]. Then, the fastener 160 can be inserted through the opening 114 and into a horizontal or vertical surface 10 [Step 206]. Next, a first end 151 of the hook 150 can be inserted through both openings 122 of the body 120 such that the hook 150 is suspended from the body 110 in a position wherein a vertical axis of the hook 150 is generally parallel with a vertical axis of the body 120 (as seen in FIG. 5) or a vertical axis of the hook 150 is generally perpendicular to a horizontal axis of the body 120 (as seen in FIG. 6) [Step 208]. Finally, an item can be hung from the hook 150 for storage [Step 210].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “storage hook device” and “device” are interchangeable and refer to the storage hook device 100 of the present invention.

Notwithstanding the forgoing, the storage hook device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the storage hook device 100 as shown in the FIGS. are for illustrative purposes only, and that many other sizes and shapes of the storage hook device 100 are well within the scope of the present disclosure. Although the dimensions of the storage hook device 100 are important design parameters for user convenience, the storage hook device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A storage hook device comprising:
a hub washer comprised of a raised area comprised of a first opening;
a body comprised of a first end comprised of a second opening, a second end comprised of a third opening, a fourth opening, and a fifth opening; and
a hook.

2. The storage hook device of claim 1, wherein the hub washer is comprised of a flat top surface.

3. The storage hook device of claim 1, wherein a first diameter of the second opening is larger than a second diameter of the recessed area.

4. The storage hook device of claim 1, wherein the raised area is positioned on a bottom surface of the hub washer.

5. The storage hook device of claim 1, wherein the fourth opening is comprised of a horizontal opening on the body.

6. The storage hook device of claim 1, wherein the fifth opening is comprised of a horizontal opening on the body.

7. The storage hook device of claim 1, wherein the hook is comprised of a coating.

8. The storage hook device of claim 7, wherein the coating is comprised of a wax or a rubber.

9. A storage hook device comprising:
a circular hub washer comprised of a raised area comprised of a first opening;
a cylindrical body comprised of a first end comprised of a second opening, a second end comprised of a third opening, a fourth opening, and a fifth opening; and
a hook.

10. The storage hook device of claim 9, wherein the circular hub washer is comprised of a flat top surface.

11. The storage hook device of claim 9, wherein a first diameter of the second opening is larger than a second diameter of the recessed area.

12. The storage hook device of claim 9, wherein the raised area is positioned on a bottom surface of the circular hub washer.

13. The storage hook device of claim 9, wherein the fourth opening is comprised of a horizontal opening on the cylindrical body.

14. The storage hook device of claim 9, wherein the fifth opening is comprised of a horizontal opening on the cylindrical body.

15. The storage hook device of claim 9, wherein the hook is comprised of a coating.

16. The storage hook device of claim 15, wherein the coating is comprised of a wax or a rubber.

17. A method of using a storage hook device, the method comprising the following steps:
providing a storage hook device comprised of:
a hub washer composed of a first opening;
a body comprised of a first end comprised of a second opening, a second end comprised of a third opening, a fourth opening, and a fifth opening;
a hook;
and a fastener;
placing the hub washer against the first end of the body such that a raised area of the hub washer extends through the second opening;
inserting the fastener through the first opening and into a surface;
inserting a first end of the hook through the fourth opening and the fifth opening; and
hanging an item from the hook.

18. The method of using a storage hook device of claim 17, wherein the surface is comprised of a vertical surface.

19. The method of using a storage hook device of claim 17, wherein the surface is comprised of a horizontal surface.

20. The method of using a storage hook device of claim 17, wherein the surface is comprised of a wall or a ceiling.
